(19) United States
(12) Patent Application Publication
(10) Pub. No.: US 2007/0181598 A1
(43) Pub. Date: Aug. 9, 2007

(54) PACKAGING SYSTEM FOR A MULTI-COMPONENT COATING COMPOSITION

(75) Inventors: David R. Cremeans, Medina, OH (US); John Richard Rassau, Allison Park, PA (US)

Correspondence Address: Carol A. Marmo;PPG Industries, Inc., Law - Intellectual Property 39S, One PPG Place, Pittsburgh, PA, 15272, US

(73) Assignee: PPG Industries Ohio, Inc., Cleveland, OH (US)

(21) Appl. No.: 11/621,712

(22) Filed: Jan. 10, 2007

Related U.S. Application Data
(60) Provisional application No. 60/764,464, filed on Feb. 2, 2006.

(51) Int. Cl. B65D 35/22; B67D 5/56

(52) U.S. Cl. 222/94; 222/129

(57) ABSTRACT

The present invention is directed to a container for storing and dispensing a multi-component coating composition. The container includes a first storage portion for holding a first coating component and a fluidly separable second storage portion for housing a second coating component. Each storage component includes a dispensing outlet for dispensing the coating component from its respective storage portion. Further, the dispensing outlets are adapted to dispense the coating components at a specific predetermined ratio.

### CROSS REFERENCE TO RELATED APPLICATION

This application claims priority to provisional application Ser. No. 60/764,464 filed Feb. 2, 2006.

### FIELD OF THE INVENTION

The present invention is directed to a packaging system for storing and dispensing a multi-component coating composition at a predetermined ratio.

### BACKGROUND

In the area of automotive coatings and particularly in the area of refinish coatings in the collision industry, coatings are formulated to include several different components where some of the components are kept separated until they are to be applied to a substrate. The components of these systems are measured and mixed, in some instances, minutes prior to the application of the coating to a substrate since these coatings are formulated to have very rapid cure. Particularly, primers and clear coats are supplied having a first film forming resin component, a second cross-linker component and a third reducer component. At the time of application, the painter measures the proper amount of each component in a relatively exact mix ratio by weighing each component on a scale or by measuring each component by volume. Once the components are measured, they are mixed together and applied to a substrate. This process takes considerable time and there is much room for error. Furthermore, due to the coatings typically having fast cure times, if an error is made in calculating the correct amount of coating to be used, either more coating must be measured to finish a particular job or the leftover coating goes to waste. Therefore, a method to dispense the coating in a more efficient manner would be greatly appreciated.

### SUMMARY OF THE INVENTION

The present invention is directed to a packaging system for storing and dispensing a multi-component coating composition. The packaging system comprises a first storage portion adapted to hold a first coating component having a first Theological profile where the first storage portion includes a first outlet that is in fluid communication with the first storage portion. Further, a second storage portion is provided and is adapted to hold a second coating component having a second rheological profile that is fluidly separable from the first storage portion and where the second storage portion includes a second outlet that is in fluid communication with the second storage portion. The first outlet and the second outlet are sized to dispense the first and second coating components at a predetermined ratio.

The present invention is also directed to methods of dispensing a multiple coating component composition at a predetermined ratio. The methods includes providing a packaging system having a first storage portion adapted to hold a first coating component having a first rheological profile. The first storage portion includes a first outlet that is in fluid communication with the first storage portion. A second storage portion is provided and is adapted to hold a second coating component having a second rheological profile. The second storage portion is fluidly separable from the first storage portion and includes a second outlet that is in fluid communication with the second storage portion. The method further includes dispensing the first coating component and the second coating component from the packaging system in a substantially simultaneously manner wherein the first outlet and the second outlet are sized to dispense the first and second coating components at a predetermined ratio.

### BRIEF DESCRIPTION OF THE DRAWINGS

FIG. 1 is a top view of a packaging system according to one embodiment of the present invention;

FIG. 2 is a side cross-sectional view of the packaging system of FIG. 1;

FIG. 3 is a side cross-sectional view of an alternative embodiment according to the present invention.

### DETAILED DESCRIPTION

The present invention is directed to a new packaging system for coatings. The new system comprises a container that separately stores different components of a coating composition and allows for dispensing the coating components at a predetermined ratio. The ratio may be by weight or volume and is more typically by volume. With this system, no measuring of components is necessary.

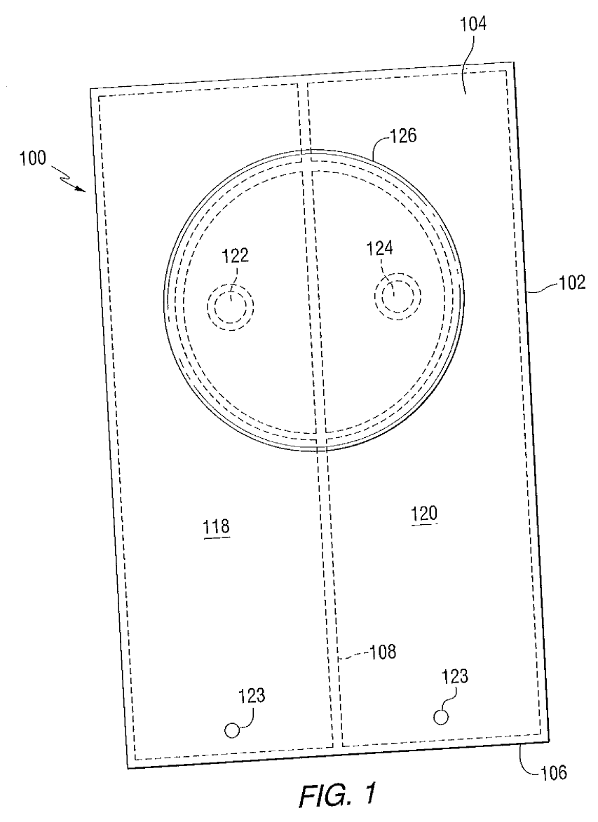

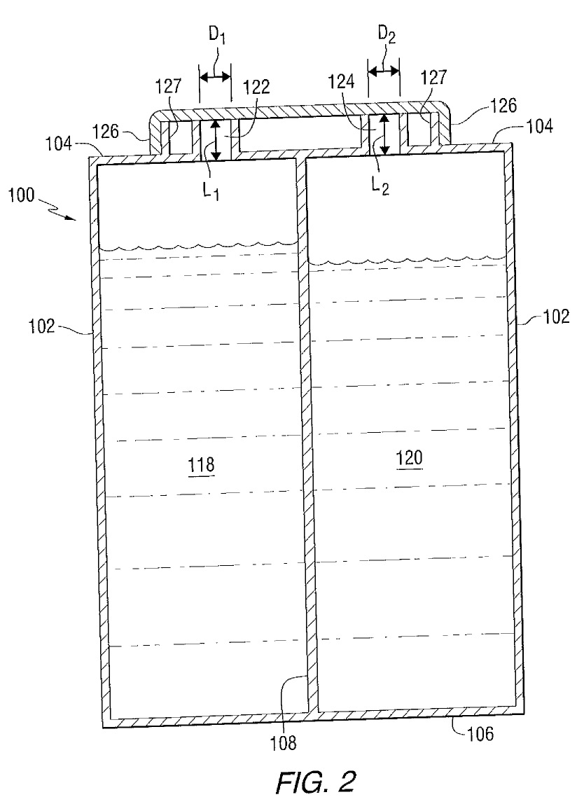

Turning now to FIG. 1 and FIG. 2, a packaging system according to the present invention comprises a container 100 having an outer wall 102. The outer wall 102 is connected to a top 104 at one end and a bottom 106 at the other end. Further, an inner wall 108 extends between portions of the side wall 102 and extends from a top 104 to the bottom 106, see FIG. 2. The wall 102, top 104 and bottom 106 of the container 100 may be rigid or flexible and can be made from any materials such as various metal and/or plastics. By flexible it is meant to include that the wall 102, top 104 and bottom 106 can be “squeezed” or “compressed” such that they return-to their original configuration when the pressure is removed. This configuration creates two separated storage compartments, a first storage compartment 118 and a second storage compartment 120 that are fluidly separated from one another. A first dispensing outlet 122 extends from the first storage compartment 118 and through the top 104 providing an outlet for dispensing a component of a coating composition from the first storage compartment 118. Likewise, a second dispensing outlet 124 extends from the second storage compartment 120, through the top 104 providing an outlet for dispensing a component of a coating composition from the second storage compartment 120. Although in the illustrative embodiment the dispensing outlets 122 and 124 are circular, other shapes or configurations such as triangular, rectangular, square, oval, and the like are within the scope of the present invention. Furthermore, more than two dispensing outlets may be utilized and the relative sizes of the dispensing outlets may vary depending on the properties of the coating component. In one embodiment, the container 100 includes a cap 126 that covers the first dispensing outlet 122 and the second dispensing outlet 124 and provides a seal to prevent evaporation of the coating components in the first storage compartment 118 and/or the second storage compartment 120. The cap 126 may be replaced after a portion of each component has been dispensed, allowing for reuse of the container 100 for multiple applications. The cap 126, when in place, is secured to the top 104 by any means as known to those of skill in the art as, for example, by a snap-type fixture or by threading to the flange 127 on the top 104.

In the illustrated embodiment, a first storage compartment 118 and a second storage compartment 120 are illustrated, however, it is contemplated that more than two storage compartments may be employed for coating systems requiring more than two components.

The first dispensing outlet 122 and the second dispensing outlet 124 are adapted to dispense coating components from the first storage compartment 118 and the second storage compartment 120 at a predetermined ratio. For example, one way of adapting the first dispensing outlet 122 and the second dispensing outlet 124 to provide a predetermined ratio of the dispensed components is to control the properties of the outlets 122 and 124 based on the rheological properties of the dispensed components. The first dispensing outlet 122 has a first diameter D₁ and a first length L₁ and the second dispensing outlet 124 has a second diameter D₂ and a second length L₂ where the ratio of the components dispensed from the outlets 122 and 124 can be a function of their respective diameters D₁ and D₂ and/or lengths L₁ and L₂. For instance, if a ratio of 1:1 is desired and the component in the first storage compartment 118 has a different Theological profile than the component in the second storage compartment 120, the first dispensing outlet 122 may have a greater dispensing diameter D₁ than the diameter D₂ of the second dispensing outlet 124 where the lengths L₁ and L₂ are relatively the same. Appropriate dispensing diameters D, and D₂ and lengths L₁ and L₂ are provided based on the rheological profiles of the coating components. It will be understood that the rheological profiles of each component can be the same or different as can the “D₁,” D₂,” and/or “L₁,” “L₂” values. Further, it will be understood that the packaging system is configured such that each of the components is delivered to a mixing vessel in a substantially simultaneous manner. By rheological profile is meant the viscosity of a component measure over a range of shear rates.

The first dispensing outlet 122 and the second dispensing outlet 124 can be adapted for any desired ratio of components. For instance, ratios of 2:1, 3:1, 3:2, 4:1, and so forth, can be realized by adjusting the first diameter D₁ and/or first length L₁ of the first dispensing outlet 122 and/or the second diameter D₂ and/or second length L₂ second dispensing outlet 124 to provide for a desired dispensing ratio based on the properties (i.e., Theological profile) of the coating components. Optional vents 123, as shown, may be employed to off-set any vacuum created during the dispensing of the components from the storage compartments. The vents 123 may also include vent caps (not shown). Other known means for off-setting any vacuum created during the dispensing of the components may be employed.

Certain coating compositions comprise components that are generally kept separated until at or near the time of application at which time the components are mixed. The mixture of components results in a coating composition that will subsequently cure. The composition may be applied to a substrate in the form of a film where subsequent curing results in a coating on the substrate. Cure can be achieved according to any means know in the art depending on the type of coating being employed. For example, in the area of automotive refinish coatings the components may include a film forming resin component, a hardener or cross-linking component that can cross link with the film forming resin component, and a reducer or solvent component. One example of a coating for use in the present invention comprises a clear coat comprising a film forming resin having hydroxyl functionality and a hardener having isocyanate groups that react with the hydroxyl functionality of the film forming resin. The components of this type of composition are kept separate until the time of application due to the reactivity of the film forming resin with the isocyanate. Further, this type of coating may be mixed at a predetermined ratio to obtain the optimal properties in the final cured film. “Predetermined ratio” as used herein refers to the ratio at which the components of a multi-component coating system are mixed together to form a coating. Examples of such ratios are described herein, such as a ratio of 1 part by volume of a first component to 2 parts by volume of a second component or 1:2. Although the ratios described herein are shown as whole numbers, i.e. 1:1, other ratios are contemplated such as, for example, 1.4:1. Further, let it be recognized that the any of the components used in the present packaging system may include additives, such as, but not limited to pigments, fillers, dyes, rheology additives, solvents, and other additives as known to those of skill in the art.

In one embodiment, the coating can be formulated to be usable with the instant packaging system by reformulating the coating into a two component system. In one embodiment, this can be accomplished by adding the reducer to either the film forming resin component or the hardener component or by dividing the reducer between the film forming resin component and the hardener component. In this fashion, a two-component system is provided that is dispensed at a specific predetermined ratio.

When employing the present packaging system, a user may pour from the container 100 an amount of a first component of the coating composition from the first storage compartment 118 and an amount of a second component of the coating composition from the second storage compartment 120 at the same time. According to various embodiments of the invention, the coating components will be dispensed at a predetermined ratio. The first component may comprise a film forming resin and the second component may comprise a hardener/cross-linker and vice versa. Once the components are poured out of the container 100, they are mixed prior to application of the coating to a substrate, such as an automobile. In certain embodiments, mixture of the components prior to application may be anywhere from a month to minutes prior to application.

Application of the coating to the substrate may be accomplished by conventional techniques. Such application techniques include, for example, spraying, wiping, brushing, and/or dipping. No weighing or volume measuring of the components is necessary. As such, if more paint is needed to complete a particular job, the painter need only to dispense a desired amount of the components from the container 100, mix the components, and apply the coating composition to a substrate. As is apparent, this is a considerable time saver and provides very little waste over conventional packaging.

In another embodiment, the container 100 may be adapted to dispense the proper ratio of components regardless of the orientation of the container 100 when dispensing the coating components.

In an alternative embodiment of the present invention, the container 100 may be employed as a “one use” packaging system. By “one use” it is meant that the container 100 houses a first coating component in the first storage compartment 118 and a second coating component in the second storage compartment 120 where the proper predetermined mix ratio is achieved when all of the first coating component and all of the second coating component are completely emptied from the container 100 and mixed prior to application. In this embodiment, after the “one use” application, the container 100 may be discarded. The “one use” packaging system, as with the other embodiments of the present invention, can be employed in any size container as known to those in the art. Suitable container sizes include pints, quarts, and/or gallons. In the “one use” packaging system, the size of the first diameter D₁ and/or length L₁ of the first dispensing outlet 122 and the size of the second diameter D₂ and/or length L₂ of the second dispensing outlet 124 becomes less significant than with other embodiments of the invention since the entire contents of the container 100 are emptied prior to application. However, other variables, such as splash during dispensing, speed of dispensing and other concerns as apparent to those in the art, may have an impact on the desired size of the first diameter D₁ and/or length L₁ of the first dispensing outlet 122 and the size of the second diameter D₂ and/or length L₂ of the second dispensing outlet 124, presence of vents, etc.

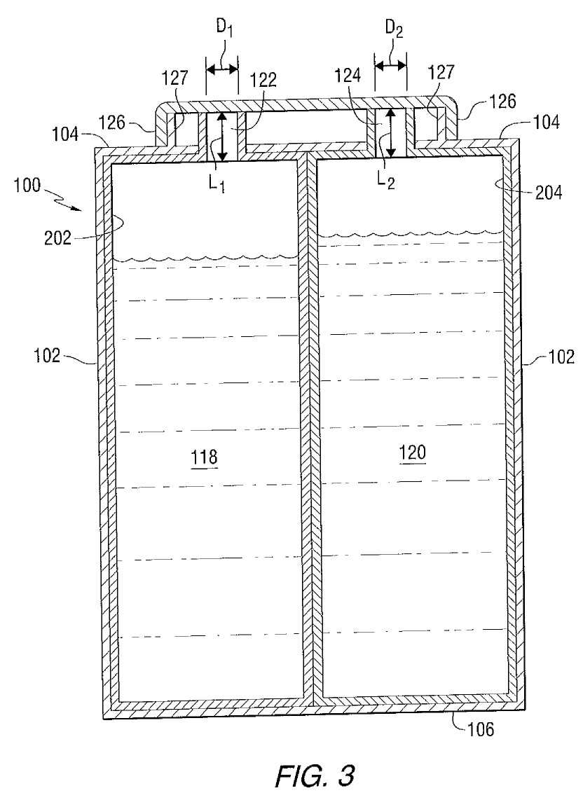

Turning now to FIG. 3, another embodiment of the present invention is shown. In this embodiment, the container 100 does not include an inner wall portion 108. The first coating component is stored in a first storage device 202 and the second component is stored is a second storage device 204 where the first storage device 202 and the second storage device 204 are inserted into the container 100. Suitable storage devices include bags and/or liners. In one embodiment, the first storage device 202 is in fluid communication with the first dispensing outlet 122 and the second storage device 204 is in fluid communication with the second dispensing outlet 124 where the size of the first dispensing outlet 122 and the size of the second dispensing outlet 124 are consistent with dispensing the components at a predetermined ratio, as described herein. In another embodiment, the individual storage devices 202 and 204 are completely emptied during application thereby providing a “one use”packaging system. In yet another embodiment, the top 104 is removeably affixed to the outer wall 202 by conventional means such that the top 104 can be periodically removed to allow for replacing the first storage device 202 and/or the second storage device 204 so that the container 100 can be reused.

Whereas particular embodiments of this invention have been described above for purposes of illustration, it will be evident to those skilled in the art that numerous variations of the details of the present invention may be made without departing from the invention as defined in the appended claims. Let it be understood that throughout this disclosure that references to the plural encompasses the singular and vice versa. For example, although reference may be made to “a” portion, “a” component, and the like, more than one is likewise contemplated.

1. A packaging system for storing and dispensing a multi-component coating composition comprising:
a. a first storage portion adapted to hold a first coating component having a first rheological profile wherein the first storage portion includes a first outlet that is in fluid communication with the first storage portion;
b. a second storage portion adapted to hold a second coating component having a second rheological profile that is fluidly separable from the first storage portion and where the second storage portion includes a second outlet that is in fluid communication with the second storage portion; and
c. wherein the first outlet and the second outlet are sized to dispense the first and second coating components at a predetermined ratio.

2. The packaging system of claim 1 wherein the first coating component and the second storage coating component are dispensed at a predetermined ratio regardless of the orientation of the container during the pouring procedure.

3. The packaging system of claim 1 wherein the predetermined dispensing ratio of the coating components is achieved by adapting the first outlet to compensate for the rheological profile of the first component and/or adapting the second outlet to compensate for the rheological profile of the second component such that the components are dispensed at a predetermined ratio irrespective of their individual rheological profiles.

4. The packaging system of claim 3 wherein the first rheological profile is different from the second rheological profile.

5. The packaging system of claim 1 further comprising a cap that covers the first outlet and second outlet during storage.

6. The packaging system of claim 1 further comprising at least one additional storage portion adapted for holding a coating component and where the at least one additional storage portion is fluidly separable from the first and second storage portions and wherein the at least one additional storage compartment includes an outlet that is in fluid communication with the at least one additional storage compartment.

7. The packaging system of claim 1 wherein the predetermined ratio of the first component to the second component is 1:1

8. The packaging system of claim 1 wherein the predetermined ratio of the first component to the second component is greater than 1:1.

9. The packaging system of claim 1 wherein the predetermined ratio of the first component to the second component is less than 1:1.

10. The packaging system of claim 1 wherein the first storage portion and the second storage portion comprise separated storage devices inserted into the packaging system.

11. The packaging system of claim 10 wherein the separated storage devices comprise bags and/or liners.

12. A packaging system for storing and dispensing a multi-component coating composition comprising:
a. a first storage portion adapted to hold a first coating component wherein the first storage portion includes a first outlet that is in fluid communication with the first storage portion; and
b. a second storage portion adapted to hold a second coating component that is fluidly separable from the first storage portion and wherein the second storage portion includes a second outlet that is in fluid communication with the second storage portion,
wherein the first coating component and the second coating component are present in the container such that the when the first component and the second component are completely dispensed from the container and mixed, a predetermined mix ratio is achieved.

13. A packaging system for storing and dispensing a multi-component coating composition comprising:
a. a first storage portion adapted to hold a first coating component comprising a film forming resin having a first rheological profile wherein the first storage portion includes a first outlet that is in fluid communication with the first storage portion;
b. a second storage portion adapted to hold a second coating component comprising a cross-linker reactive with the film forming resin and having a second Theological profile, wherein the second storage portion is fluidly separable from the first storage portion and wherein the second storage portion includes a second outlet that is in fluid communication with the second storage portion; and
c. wherein the first outlet and the second outlet are sized to dispense the first and second coating components at a predetermined ratio.

14. The packaging system of claim 13 wherein the first storage portion and second storage portion comprise separated storage devices inserted into the container.

15. The packaging system of claim 14 wherein the separated storage devices comprise bags and/or liners.

16. A method of dispensing a multiple component coating composition at a predetermined ratio comprising:
a. providing a packaging system comprising
i. a first storage portion adapted to hold a first coating component having a first rheological profile wherein the first storage portion includes a first outlet that is in fluid communication with the first storage portion; and
ii. providing a second storage portion adapted to hold a second coating component having a second rheological profile that is fluidly separable from the first storage portion and where the second storage portion includes a second outlet that is in fluid communication with the second storage portion; and
b. dispensing the components from the packaging system wherein the first coating component is dispensed from the first storage portion and the second coating component is dispensed from the second storage portion in substantially simultaneous manner and wherein the first outlet and the second outlet are sized to dispense the first and second coating components at a predetermined ratio.
